(19) United States
(12) Patent Application Publication
(10) Pub. No.: US 2004/0189624 A1
(43) Pub. Date: Sep. 30, 2004

(54) Method and system for controlling a display device

(76) Inventors: Giuseppe Pasqualini, Monza (MI) (IT); Luigi Albani, Merate (IT)

Correspondence Address: Corporate Patent Counsel, Philips Electronics North America Corporation, Po Box 3001, Briarcliff Manor, NY, 10510, US

(21) Appl. No.: 10/487,733

(22) PCT Filed: Aug. 26, 2002
(86) PCT No.: PCT/IB02/03538

(30) Foreign Application Priority Data
Aug. 27, 2001 (EP) 01203228.0

(51) Int. Cl. G09G 5/00

(52) U.S. Cl. 345/204

(57) ABSTRACT

A computer system (11) comprises a computer (2) and a monitor (5), the computer being provided with a mouse (4) as an input device, the monitor being provided with On Screen Display (OSD) facility. The computer is adapted to send control information (MSI) regarding the status of the mouse to the monitor. The monitor is adapted to evaluate the control information (MSI) received from the computer, and to adjust a relevant operational parameter.

The present invention relates in general to the control of a display device such as a monitor, and more particularly to the adjustment of display settings. In the following the invention will be explained specifically for the adjustment of the brightness of a computer monitor, but a skilled person will recognize that the invention is equally applicable to other types of settings, such as for instance contrast, color, geometry, etc.

In principle, a monitor is a hardware device that can be considered a peripheral device for a computer or the like. More particularly, although a monitor is generally considered part of an overall computer system, the monitor is in fact only an output device for the actual computer, intended to present information to the user. As such, the monitor is an apparatus capable of receiving image signals from a computer and projecting an image on its screen in correspondence with those signals. However, the monitor has various control parameters or settings that can be adjusted by the user as he likes, which define how the monitor projects the image; for instance, the setting “brightness” defines how bright the image is projected.

Conventionally, monitors have been equipped with dedicated buttons or knobs for adjusting such settings. However, there is no standardization for such buttons, while such buttons are further usually hidden behind some kind of lid in order to improve the overall appearance of the monitor design. This makes it difficult for a user to find and use the buttons adequately, especially in an initial stage of use: the user must “get used” to the apparatus.

The above applies to monitors of the type where the adjustment of settings is implemented in hardware, such as for instance in potentiometers, but also applies to more modem monitors equipped with an On Screen Display (OSD) system. In such monitors, when an adjustment mode is entered, the OSD system displays information regarding the settings. Navigating through the OSD information, amending settings and confirming choices is done by actuation of such dedicated buttons as mentioned above. Although such monitors offer improved ease of use with respect to conventional monitors, it is still a problem that there is no standardization in the control buttons for the OSD system, with the consequence that various manufacturers offer various solutions which differ from each other. Therefore, even with this type of monitor, the user must go through a typical learning phase to get used to the specific user interface of his specific monitor.

It is, inter alia, an object of the invention to provide a monitor of the OSD type with improved ease of use. To this end, a first aspect of the invention provides a method of adjusting display settings as claimed in claim 1. A second aspect of the invention provides a system to influence parameters of a display device as claimed in claim 5.

Nowadays, users are more and more used to working with computers, especially with computers having a graphics interface for inputting commands. A typical example of an input device using a graphics interface is the well-known mouse, with which the user can move a pointer icon on the computer display, the position of the pointer icon corresponding to a certain command, which command is confirmed by depressing a certain button on the mouse device (“clicking”).

According to an important aspect of the present invention, it is proposed to utilize the user's experience with computers, and to allow him to use the computer's own input devices for adjusting monitor settings in monitors of the OSD type. More particularly, it is proposed to use the computer's own input devices for navigating through the OSD system, for amending settings and for confirming choices.

A particularly suitable computer input device is the mouse; in such implementation, the computer sends to the monitor information relating to the mouse, which information is used by the monitor's OSD system for navigation, inputting choices, etc. However, it is also possible to use other computer input devices, for instance a keyboard (especially arrow keys, ENTER keys, etc), or even a voice interface (especially spoken commands like “right”, “left”, “up”, “down”, “confirm”, etc).

It is to be noted that the mouse is an input device for the computer, not for the monitor; the monitor has its own input devices, i.e. buttons, and it has a signal input, while it is further arranged for processing and projecting an input signal. The present invention proposes to use said signal not only for sending image information to the monitor but also for sending OSD control information to the monitor.

If desired, the monitor can still be equipped with its own input buttons, but in the context of the present invention those buttons can be omitted, which is a cost-saving aspect.

It is to be noted that the idea of having the computer send control signals to the monitor is known per se. For instance, U.S. Pat. No. 5,654,743 and U.S. Pat. No. 5,550,556 disclose systems in which control signals are sent from the computer to the monitor in order to change the settings of the monitor. However, in these prior art systems, the control signals are actual control signals ordering the monitor to adapt a specified parameter to a specified value. This implies that a relatively complicated command structure should be implemented, including codes for the various parameters, codes for the various values, etc. Furthermore, any On Screen Display facilities of the monitor would be rendered useless. In contrast, according to the present invention, the computer only sends to the monitor status information relating to the input device; for instance, in the case of a mouse input device, the computer might send to the monitor a signal indicating the pressing of a mouse button. Thus, the computer basically sends to the monitor the same information as received from the input device; the interpretation of such information is left to the monitor. Advantageously, this information is used to navigate through a possible On Screen Display facility of the monitor.

These and other aspects, features and advantages of the present invention will be explained in more detail by the following description of preferred embodiments of the present invention, with reference to the drawings, in which like reference numerals indicate like or similar components, and in which:

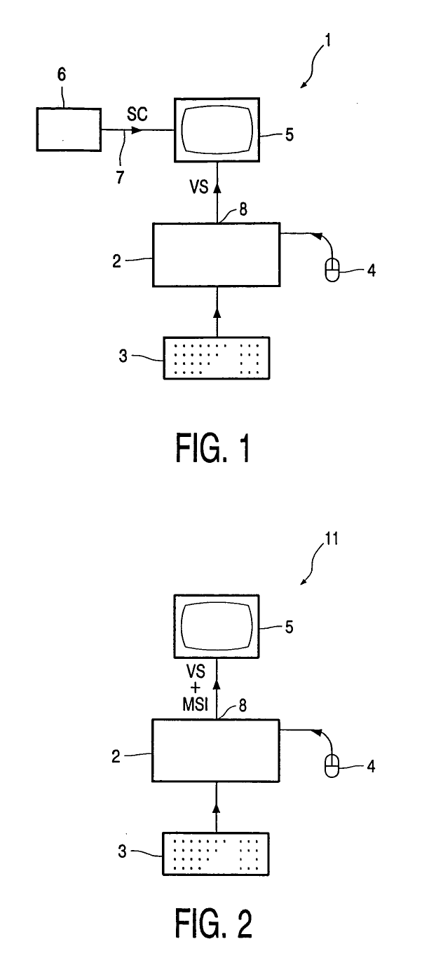

FIG. 1 schematically illustrates a prior art configuration of a computer with a monitor;

FIG. 2 schematically illustrates a configuration of a computer with a monitor in accordance with the present invention;

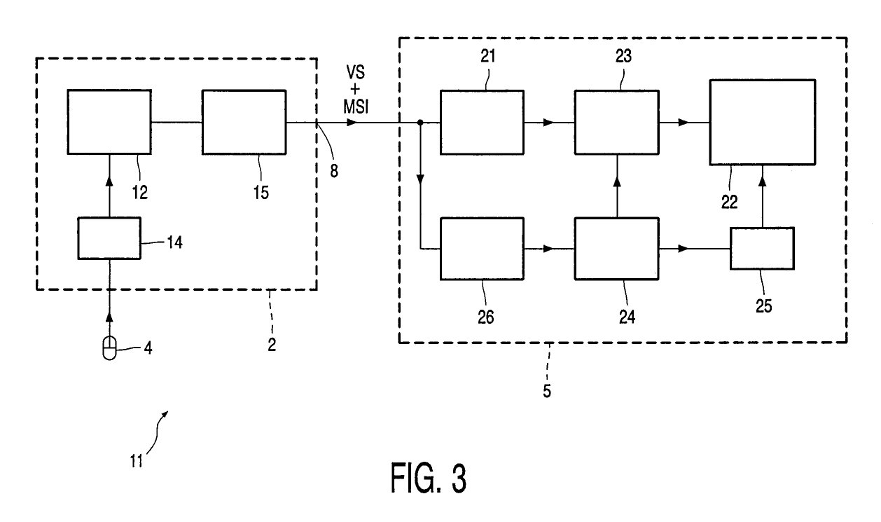

FIG. 3 is a functional block diagram illustrating specific embodiments of the invention.

FIG. 1 schematically illustrates a prior art configuration of a computer system, generally indicated by the reference numeral 1. The heart of the computer system is the actual computer 2, usually comprising one or more processors within a common housing. The computer system 1 further comprises input devices for the actual computer 2; typically, as illustrated, the actual computer 2 is provided with a first input device 3 in the form of a keyboard, and a second input device 4 in the form of a pointer device, indicated hereinafter as a “mouse”. The computer system 1 may comprise further input devices for the actual computer 2. Furthermore, the input devices may be incorporated in the common housing for the actual computer, or they may be separate devices, coupled to the actual computer by wirelink or wirelesslink.

The computer system 1 further comprises at least one output display device 5 for the actual computer 2, comprising a display screen for projecting images to be viewed by the user. Such display device 5 will hereinafter generally be indicated as “monitor”, but it should be clear that the present invention is applicable to all types of display devices, including LCD panels, plasma display panels, etc. The monitor 5 is connected to a monitor output port 8 of the actual computer 2. The output signals generated by the computer 2 at its monitor output port 8, intended to result in the projection of an image when processed by the monitor 5, will be referred to as video signals VS.

In the prior art computer system 1, the monitor 5 is provided with at least one dedicated input device 6. Through this dedicated monitor input device 6, the user can adjust monitor settings such as brightness, contrast, etc. This dedicated monitor input device 6 can be implemented in the form of one ore more buttons, knobs, or pointing devices.

Normally, the dedicated monitor input device 6 is incorporated in the monitor housing. However, for the sake of the present discussion, the dedicated monitor input device 6 is illustrated as being separate from the monitor 5. Importantly, in the prior art computer system 1, the dedicated monitor input device 6 is coupled directly to the monitor 5 through a link 7. Thus, a setting command SC for the monitor 5 is sent directly from the dedicated monitor input device 6 to the monitor 5.

In a particular case, the monitor 5 is provided with On Screen Display (OSD) facility, which means that graphical information, such as a menu, regarding choices to be made and parameters to be set is displayed on the monitor screen. The user makes his choice and inputs his settings through the dedicated monitor input device 6, which allows him to navigate through the options projected on the monitor screen. In a specific embodiment, the OSD comprises a pointer, and the dedicated monitor input device 6 comprises buttons controlling the position of the pointer.

In a computer system in accordance with the present invention, the monitor no longer need a dedicated monitor input device, as will be explained in the following.

FIG. 2 schematically illustrates a configuration of a computer system 11 in accordance with the present invention. Like components are indicated by the like reference numerals. For adjusting monitor settings such as brightness, contrast, geometry, etc., the monitor 5 does not need any dedicated monitor input device like the prior art device 6, and, therefore, no such dedicated monitor input device is shown in FIG. 2. In contrast, if the user wants to adjust a monitor setting, he uses a computer input device to communicate with the monitor's OSD facility. In the following, the invention will be specifically explained for the case of a computer mouse 4 being used, but a skilled person will recognize that the invention is not limited to this explanation.

As an input device, the mouse 4 inputs information in the computer. This information relates to the current status of the mouse, and will therefore be indicated as mouse status information MSI. This mouse status information MSI relates to, for instance, actuation of mouse buttons, wheel actions, etc. The computer 2 will pass this information on to the monitor 5 via the monitor output port 8 of the computer 2, so that the monitor 5 will receive the same information as the computer. Possibly, the computer 2 will also pass on information relating to the coordinates of a pointer; for the sake of the present invention, such information will also be covered by the phrase “mouse status information”.

The OSD system on board of the monitor 5 is adapted to evaluate the mouse status information MSI received from the computer, and to generate adequate adjustment commands for the relevant monitor parameter(s).

Two possible embodiments will now be discussed in more detail with reference to FIG. 3.

In a first embodiment, the computer 2 is adapted to embed the mouse status information MSI in the video information sent to the monitor 5. For instance, the mouse status information MSI can be coded in a specific video line (preferably a line in the non-displayed area). However, the mouse status information MSI can also be coded as a specific pixel value for one or more pixels.

FIG. 3 illustrates that the host system 2 (computer) comprises a central processing unit 12, which receives the actual signals from the computer input device 4 (mouse) via an input port 14. The computer 2 further comprises a video encoder 15, for instance a computer graphics card, which is designed for generating video signals at the video output port 8. The video encoder 15 has an input coupled to the central processing unit 12. The central processing unit 12 is adapted to translate the actual signals as received from the computer input device 4 into a specific code, and to send this code to the video encoder 15, which includes this code in the video signals by any suitable video encoding technique, for instance by modulating a specific video line, or by setting the value of specific predetermined pixels.

FIG. 3 further illustrates that the monitor 5 comprises video processing circuitry 21 for receiving and processing the video signal VS from the computer, and for generating the relevant signals for the display 22, as usual. The monitor 5 further comprises an OSD system 23, adapted to generate relevant signals for the display 22 in order to display the OSD information on the display 22. In FIG. 3, the OSD system 23 is shown between video processing circuitry 21 and display 22, in order to indicate that the OSD information display can be given priority over the video display if the OSD system is switched on.

The monitor 5 further comprises a master processing unit 24, adapted to activate and control the OSD system 23. In FIG. 3, the master processing unit 24 is shown as a unit separate from the OSD system 23, but the master processing unit 24 and the OSD system 23 can also be integrated as a single unit. The master processing unit 24 is also adapted to control the setting of monitor parameters such as brightness, which determine how a video signal is projected by the display 22. These monitor parameters are symbolized by block 25, which may be considered as being a memory with parameter values.

The monitor 5 further comprises a decoder 26, which also receives the input signal from the computer 2. In FIG. 3, the decoder 26 is shown as a unit separate from the video processing circuitry 21, but the decoder 26 and the video processing circuitry 21 can also be integrated as a single unit. The decoder 26 decodes the mouse status information MSI from the encoded video signal, and sends this mouse status information MSI to the master processing unit 24 in order to enable the master processing unit 24 to change the settings of the monitor.

In another embodiment, where the OSD system is designed to display an OSD pointer, use is made of a pointer image generated by the video encoder 15 under the control of the central processor unit 12. This pointer image is usually generated in the form of a bit map, corresponding to pixels of the pointer image. In this embodiment of the invention, the central processing unit 12 is adapted to change the pointer bit map in a predetermined way and in dependence on the mouse status, so that the current bit map reflects the current mouse status. In other words, the mouse status is encoded in the computer pointer image.

As in the previous embodiment, the monitor 5 comprises a decoder 26, which is preferably part of the software in video processing circuitry 21. Now, the decoder 26 is adapted to investigate the bit map of the computer pointer image and to derive the mouse status information MSI from it.

In a possible embodiment, the decoder 26 is adapted to automatically recognize the pointer position; in that case, the computer does not need to send the pointer position information to the monitor, which makes the process of information transfer easier.

It is noted that, in this embodiment, there may be two pointers: one computer pointer generated by the computer (and carrying the information to be transferred) and optionally one OSD pointer generated by the OSD system. Preferably, the OSD system is adapted to display its OSD pointer to replace the computer pointer, so that the OSD pointer follows the mouse movements while further the encoded computer pointer is further not visible to the user.

It will be evident to a person skilled in the art that the present invention is not limited to the example discussed above, but that alternatives, amendments, modifications and variations are possible within the scope of the invention as defined in the accompanying claims.

For instance, although the setting of monitor 5 has been described in the above in association with a computer 2, the monitor may be associated with other host devices. Also the central processor 12 may be implemented in hardware, but preferably the functions described above are implemented in software.

Furthermore, the communication of mouse status information from computer to monitor is only required in a monitor setting mode. How such mode is entered and closed is not relevant here, since this can be done in several ways known per se. Within the context of the present invention it is possible that the computer is adapted to communicate mouse status information to the monitor during such monitor setting mode only, but it is also possible that the computer is adapted to always communicate mouse status information to the monitor, which information is ignored by the monitor except during such monitor setting mode. In the latter case, it is also possible for a command signal for entering and leaving monitor setting mode to be generated by the computer and included in said mouse status information MSI.

Also an additional connection between the computer 2 and monitor 5 is possible for transferring the mouse status information MSI. In this case fewer coding and decoding means are required.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of adjusting display settings of a display device which receives picture information from a host device, the host device receiving input information from an input device, the method comprising the step of sending control information (MSI) relating to input information for adjusting the display settings to the display device.

2. A method as claimed in claim 1, wherein display setting information is displayed on a screen of the display device, and in that said control information (MSI) is recognized by the display device and processed as a command in relation to the display setting information displayed on said screen.

3. A method as claimed in claim 2, wherein said control information (MSI) is recognized by the display device and processed as a command for navigation through On Screen Display menus and for entering On Screen Display choices.

4. A method as claimed in claim 1, comprising the step of sending the control information (MSI) to the display device together with the picture information.

5. A system, comprising:
a host device,
an input device coupled to the host device;
a display device coupled to the host device as an output device, the display device having at least one operational parameter influencing the operation of the display device;
wherein the host device is adapted to send to the display device control information (MSI) corresponding to signals input by the input device;
and wherein the display device comprises an evaluation circuit for evaluating the control information (MSI) received from the host device, and to generate adequate internal adjustment commands for the at least one operational parameter.

6. A system as claimed in claim 5, wherein the host device is adapted to embed the control information (MSI) in the video information sent to the display device.

7. A system as claimed in claim 6, wherein the host device is adapted to encode the control information (MSI) in a specific video line.

8. A system as claimed in claim 6, wherein the host device is adapted to encode the control information (MSI) in a specific pixel value for one or more pixels.

9. A system claimed in any of claims 5-8, wherein the display device comprises:
decoding means for receiving the video signal encoded by the host device, to decode the control information (NSI); and
control means, coupled to receive from the decoding means the decoded control information (MSI), comprising setting control means to change the settings of the display device on the basis of the decoded control information (MSI) received from the decoding means.

10. A system as claimed in any of claims 5-9,
wherein the input device for the host device is a pointer device, preferably a computer mouse;
and in that the control information (MSI) relates to the control of the pointer device, such as for instance mouse coordinates, actuation of buttons, wheel actions, etc.

11. A system as claimed in any of claims 5-10,
wherein the display device is a monitor provided with an On Screen Display system;
the monitor being adapted to utilize the received control information (MSI) for navigation through the options displayed on screen and inputting user choices.
